(19) United States
(12) Patent Application Publication
(10) Pub. No.: US 2025/0261254 A1
(43) Pub. Date: Aug. 14, 2025

(54) METHOD FOR CONTROLLING CROSS-DOMAIN DEVICE, AND CONTROL TERMINAL, SERVER AND SYSTEM

(71) Applicants: Beijing BOE Technology Development Co., Ltd., Beijing (CN); BOE Technology Group Co., Ltd., Beijing (CN)

(72) Inventors: Junjie ZHAO, Beijing (CN); Jing SU, Beijing (CN); Shaobei CHEN, Beijing (CN); Hongbo FENG, Beijing (CN)

(21) Appl. No.: 18/856,836

(22) PCT Filed: Apr. 13, 2023
(86) PCT No.: PCT/CN2023/088055

§ 371 Date: Oct. 14, 2024

(30) Foreign Application Priority Data
Apr. 20, 2022 (CN) 202210417197.3

(51) Int. Cl. H04W 76/10; H04W 4/80; H04W 12/06; H04W 60/00

(52) U.S. Cl. CPC H04W 76/10; H04W 4/80; H04W 12/06; H04W 60/00

(57) ABSTRACT

Provided in the present disclosure are a method for controlling a cross-domain device, and a control terminal, a server and a system. The method includes: a first control terminal sending a first request message to a server of a smart device, wherein the first control terminal is located in a first device domain, the smart device is located in a second device domain, and the first request message is used for requesting a second control terminal, which is located in the second device domain; the first control terminal determining that the smart device is allowed to be added to the first device domain, and the first control terminal establishing a session connection with the smart device; and the first control terminal sending a first certificate of the first device domain to the smart device by means of the session connection.

### CROSS REFERENCE TO RELATED APPLICATION

The present application is a national phase entry under 35 U.S.C § 371 of International Application No. PCT/CN2023/088055, filed on Apr. 13, 2023, which claims the priority of the Chinese patent application submitted to the China National Intellectual Property Administration on Apr. 20, 2022, with the application number 20/2210417197.3 and the application name “Method for Controlling Cross-Domain Device, and Control Terminal, Server and System”, the entire contents of which are incorporated in the present application by reference.

### TECHNICAL FIELD

The present disclosure relates to the field of wireless communications, and in particular to a method, control terminal, server and system for controlling a cross-domain device.

### BACKGROUND

With the development of Internet of Things (IoT) technology, IoT devices are being used in a wider range of applications. Taking a smart home as an example, users can access and control smart home devices through smart devices.

In the process of using smart devices, different family members may have needs to manage and access smart devices. Existing smart devices do not support multiple managers, which is not conducive to the promotion and use of smart devices.

### SUMMARY

The present disclosure provides a method, control terminal, server, and system for controlling a cross-domain device, enabling new managers to add smart devices more conveniently in smart home scenarios, promoting the sharing and use of smart devices in pan home scenarios, and meeting scenarios of multi user control of smart devices.

In a first aspect, embodiments of the present disclosure provide a method for controlling a cross-domain device, including:
sending, by a first control terminal, a first request message to a server of a smart device, where the first control terminal is in a first device domain, the smart device is in a second device domain, and the first request message is configured to request a second control terminal in the second device domain to allow the first control terminal to add the smart device to the first device domain;
determining, by the first control terminal, that the smart device is allowed to be added to the first device domain; establishing, by the first control terminal, a session connection with the smart device; and
sending, by the first control terminal, a first certificate of the first device domain to the smart device through the session connection, so that the first control terminal communicates securely with the smart device based on the first certificate.

As an optional embodiment, the method further includes:
controlling, by the first control terminal, the smart device according to control authority information determined by the second control terminal, where the control authority information includes control authority and control period.

As an optional embodiment, the sending, by the first control terminal, the first request message to the server of the smart device, includes:
obtaining, by the first control terminal, an address of the server of the smart device, and accessing a device page of the smart device according to the address of the server; and
sending, by the first control terminal, the first request message to the server through the device page.

As an optional embodiment, the obtaining, by the first control terminal, the address of the server of the smart device, includes:
establishing, by the first control terminal, a communication connection with the smart device through Near Field Communication (NFC) or Bluetooth, and obtaining the address of the server of the smart device.

As an optional embodiment, the obtaining, by the first control terminal, the address of the server of the smart device, includes:
sending, by the first control terminal, a first broadcast message through DNS-SD, and receiving a response message of the first broadcast message, where the response message includes information associated with the smart device; and
determining the address of the server of the smart device according to the information associated with the smart device.

As an optional embodiment, the accessing, by the first control terminal, the device page of the smart device according to the address of the server, includes:
sending, by the first control terminal, authentication information of the first control terminal to the server according to the address of the server; and
when the server verifies and passes the authentication information, entering and accessing, by the first control terminal, the device page of the smart device.

As an optional embodiment, the first request message includes at least one of an identifier of the first control terminal, a type of the first control terminal, an identifier of the smart device, a request validity period, a request purpose, or a request reason.

As an optional embodiment, the first request message includes identity information of the first control terminal, and the identity information is used for determining whether the first control terminal meets a trigger condition determined by the second control terminal and determining that the smart device is allowed to be added to the first device domain when the trigger condition is met.

As an optional embodiment, the server includes a server registered by the smart device or a smart device with a local server function.

As an optional embodiment, the determining, by the first control terminal, that the smart device is allowed to be added to the first device domain, includes:
receiving, by the first control terminal, a second broadcast message from the smart device through Domain Name System Service Discovery (DNS-SD) and determining that the smart device is allowed to be added to the first device domain.

In a second aspect, embodiments of the present disclosure provide a method for controlling a cross-domain device, including:
receiving, by a second control terminal, a second request message from a server of a smart device, where the second control terminal and the smart device are in a second device domain, and the second request message is configured to trigger the second control terminal to allow the smart device to be added by the first control terminal to a first device domain where the first control terminal is located; and
sending, by the second control terminal, a third request message to the smart device, where the third request message is configured to trigger the smart device to start a pairing mode, so that the first control terminal adds the smart device to the first device domain.

As an optional embodiment, the method further includes:
sending, by the second control terminal, a fourth request message to the smart device, where the fourth request message is configured to indicate control authority information of the first control terminal on the smart device.

As an optional embodiment, the fourth request message includes control authority and control period of the first control terminal on the smart device.

As an optional embodiment, the second request message includes at least one of an identifier of the first control terminal, a type of the first control terminal, an identifier of the smart device, a request validity period, a request purpose, or a request reason.

As an optional embodiment, the third request message includes at least one of an identifier of the first control terminal, a request validity period, or a start time of the smart device receiving a request.

As an optional embodiment, the second request message includes identity information of the first control terminal, and the identity information is used for determining whether the first control terminal meets a trigger condition determined by the second control terminal and determining that the smart device is allowed to be added to the first device domain when the trigger condition is met.

As an optional embodiment, the server includes a server registered by the smart device or a smart device with a local server function.

In a third aspect, embodiments of the present disclosure provide a method for controlling a cross-domain device, including:
receiving a first request message from a first control terminal, where the first control terminal is in a first device domain, the first request message is configured to request a second control terminal to allow the first control terminal to add the smart device to a first device domain, and the second control terminal and the smart device are in a second device domain; and
sending a second request message to the second control terminal, where the second request message is configured to trigger the second control terminal to allow the smart device to be added by the first control terminal to the first device domain where the first control terminal is located.

As an optional embodiment, the receiving the first request message from the first control terminal, includes:
generating a device page of the smart device, and receiving the first request message from the first control terminal through the device page.

As an optional embodiment, the receiving the first request message from the first control terminal through the device page, includes:
receiving authentication information from the first control terminal; and
when the authentication information is verified and passed, receiving the first request message from the first control terminal through the device page.

As an optional embodiment, the first request message includes at least one of an identifier of the first control terminal, a type of the first control terminal, an identifier of the smart device, a request validity period, a request purpose, or a request reason.

As an optional embodiment, the second request message includes at least one of an identifier of the first control terminal, a type of the first control terminal, an identifier of the smart device, a request validity period, a request purpose, or a request reason.

In a fourth aspect, embodiments of the present disclosure provide a system for controlling a cross-domain device, including a first control terminal, a second control terminal, a smart device, and a server of the smart device, where:
the first control terminal sends a first request message to the server of the smart device, where the first control terminal is in a first device domain, the smart device is in a second device domain, and the first request message is configured to request the second control terminal in the second device domain to allow the first control terminal to add the smart device to the first device domain;
the server sends a second request message to the second control terminal, where the second request message is configured to trigger the second control terminal to allow the smart device to be added by the first control terminal to the first device domain where the first control terminal is located;
the second control terminal sends a third request message to the smart device, where the third request message is configured to trigger the smart device to start a pairing mode, so that the first control terminal adds the smart device to the first device domain; and
the first control terminal determines that the smart device is allowed to be added to the first device domain, establishes a session connection with the smart device, and sends a first certificate of the first device domain to the smart device through the session connection, so that the first control terminal communicates securely with the smart device based on the first certificate.

As an optional embodiment, the system further includes:
the second control terminal sending a fourth request message to the smart device, where the fourth request message is configured to indicate control authority information of the first control terminal on the smart device; and
the first control terminal controlling the smart device according to the control authority information determined by the second control terminal.

As an optional embodiment, the fourth request message includes control authority and control period of the first control terminal on the smart device.

As an optional embodiment, the first control terminal sends the first request message to the server of the smart device, including:
the first control terminal obtaining an address of the server of the smart device and accessing a device page of the smart device according to the address of the server; and
the first control terminal sending the first request message to the server through the device page.

As an optional embodiment, the first control terminal obtains the address of the server of the smart device, including:
the first control terminal establishing a communication connection with the smart device through NFC or Bluetooth, and obtaining the address of the server of the smart device.

As an optional embodiment, the first control terminal obtains the address of the server of the smart device, including:
the first control terminal sending a first broadcast message through DNS-SD and receiving a response message of the first broadcast message, where the response message includes information associated with the smart device; and
determining the address of the server of the smart device according to the information associated with the smart device.

As an optional embodiment, the first control terminal accesses the device page of the smart device according to the address of the server, including:
the first control terminal sending authentication information of the first control terminal to the server according to the address of the server; and
when the server verifies and passes the authentication information, the first control terminal entering and accessing the device page of the smart device.

As an optional embodiment, the first request message includes at least one of an

identifier of the first control terminal, a type of the first control terminal, an identifier of the smart device, a request validity period, a request purpose, or a request reason.

As an optional embodiment, the first request message includes identity information of the first control terminal, and the identity information is used for determining whether the first control terminal meets a trigger condition determined by the second control terminal and determining that the smart device is allowed to be added to the first device domain when the trigger condition is met.

As an optional embodiment, the server includes a server registered by the smart device or a smart device with a local server function.

As an optional embodiment, the second request message includes at least one of an identifier of the first control terminal, a type of the first control terminal, an identifier of the smart device, a request validity period, a request purpose, or a request reason.

As an optional embodiment, the second request message includes identity information of the first control terminal, and the identity information is used for determining whether the first control terminal meets a trigger condition determined by the second control terminal, and determining that the smart device is allowed to be added to the first device domain when the trigger condition is met.

As an optional embodiment, the third request message includes at least one of an identifier of the first control terminal, a request validity period, or a start time of the smart device receiving a request.

As an optional embodiment, the first control terminal determines that the smart device is allowed to be added to the first device domain, including:
the first control terminal receiving a second broadcast message from the smart device through DNS-SD and determining that the smart device is allowed to be added to the first device domain.

In a fifth aspect, embodiments of the present disclosure provide a control terminal, including a processor and a memory, where the memory is configured to store programs executable by the processor, and the processor is configured to read the programs in the memory and execute the following steps:
sending, by a control terminal, a first request message to a server of a smart device, where the control terminal is in a first device domain, the smart device is in a second device domain, and the first request message is configured to request a second control terminal in the second device domain to allow the control terminal to add the smart device to the first device domain;
determining, by the control terminal, that the smart device is allowed to be added to the first device domain, where the control terminal establishes a session connection with the smart device; and
sending, by the control terminal, a first certificate of the first device domain to the smart device through the session connection, so that the control terminal communicates securely with the smart device based on the first certificate.

As an optional embodiment, the processor is specifically configured to execute:
controlling, by the control terminal, the smart device according to control authority information determined by the second control terminal, where the control authority information includes control authority and control period.

As an optional embodiment, the processor is specifically configured to execute:
obtaining, by the control terminal, an address of the server of the smart device, and accessing a device page of the smart device according to the address of the server; and
sending, by the control terminal, the first request message to the server through the device page.

As an optional embodiment, the processor is specifically configured to execute:
establishing, by the control terminal, a communication connection with the smart device through NFC or Bluetooth, and obtaining the address of the server of the smart device.

As an optional embodiment, the processor is specifically configured to execute:
sending, by the control terminal, a first broadcast message through DNS-SD, and receiving a response message of the first broadcast message, where the response message includes information associated with the smart device; and
determining the address of the server of the smart device according to the information associated with the smart device.

As an optional embodiment, the processor is specifically configured to execute:
sending, by the control terminal, authentication information of the control terminal to the server according to the address of the server; and
when the server verifies and passes the authentication information, entering and accessing, by the control terminal, the device page of the smart device.

As an optional embodiment, the first request message includes at least one of a control terminal identifier, a control terminal type, an identifier of the smart device, a request validity period, a request purpose, or a request reason.

As an optional embodiment, the first request message includes identity information of the control terminal, and the identity information is used for determining whether the control terminal meets a trigger condition determined by the second control terminal and determining that the smart device is allowed to be added to the first device domain when the trigger condition is met.

As an optional embodiment, the server includes a server registered by the smart device or a smart device with a local server function.

As an optional embodiment, the processor is specifically configured to execute:
receiving, by the control terminal, a second broadcast message from the smart device through DNS-SD and determining that the smart device is allowed to be added to the first device domain.

In a sixth aspect, embodiments of the present disclosure provide a control terminal, including a processor and a memory, where the memory is configured to store programs executable by the processor, and the processor is configured to read the programs in the memory and execute the following steps:
receiving, by a control terminal, a second request message from a server of a smart device, where the control terminal and the smart device are in a second device domain, and the second request message is configured to trigger the control terminal to allow the smart device to be added by the first control terminal to a first device domain where the first control terminal is located; and
sending, by the control terminal, a third request message to the smart device, where the third request message is configured to trigger the smart device to start a pairing mode, so that the first control terminal adds the smart device to the first device domain.

As an optional embodiment, the processor is specifically configured to execute:
sending, by the control terminal, a fourth request message to the smart device, where the fourth request message is configured to indicate control authority information of the first control terminal on the smart device.

As an optional embodiment, the fourth request message includes control authority and control period of the first control terminal on the smart device.

As an optional embodiment, the second request message includes at least one of an identifier of the first control terminal, a type of the first control terminal, an identifier of the smart device, a request validity period, a request purpose, or a request reason.

As an optional embodiment, the third request message includes at least one of an identifier of the first control terminal, a request validity period, or a start time of the smart device receiving a request.

As an optional embodiment, the second request message includes identity information of the first control terminal, and the identity information is used for determining whether the first control terminal meets a trigger condition determined by the control terminal and determining that the smart device is allowed to be added to the first device domain when the trigger condition is met.

As an optional embodiment, the server includes a server registered by the smart device or a smart device with a local server function.

In a seventh aspect, embodiments of the present disclosure provide a server, including a processor and a memory, where the memory is configured to store programs executable by the processor, and the processor is configured to read the programs in the memory and execute the following steps:
receiving a first request message from a first control terminal, where the first control terminal is in a first device domain, the first request message is configured to request a second control terminal to allow the first control terminal to add the smart device to a first device domain, and the second control terminal and the smart device are in a second device domain; and
sending a second request message to the second control terminal, where the second request message is configured to trigger the second control terminal to allow the smart device to be added by the first control terminal to the first device domain where the first control terminal is located.

As an optional embodiment, the processor is specifically configured to execute:
generating a device page of the smart device, and receiving the first request message from the first control terminal through the device page.

As an optional embodiment, the processor is specifically configured to execute:
receiving authentication information from the first control terminal; and
when the authentication information is verified and passed, receiving the first request message from the first control terminal through the device page.

As an optional embodiment, the first request message includes at least one of an identifier of the first control terminal, a type of the first control terminal, an identifier of the smart device, a request validity period, a request purpose, or a request reason.

As an optional embodiment, the second request message includes at least one of an identifier of the first control terminal, a type of the first control terminal, an identifier of the smart device, a request validity period, a request purpose, or a request reason.

In an eighth aspect, embodiments of the present disclosure provide a computer storage medium, on which computer programs are stored, where when the programs are executed by a processor, steps of the method in the first aspect or the second aspect or the third aspect are implemented.

These or other aspects disclosed herein will be more concise and understandable in the description of the following embodiments.

### BRIEF DESCRIPTION OF FIGURES

In order to more clearly illustrate the technical solutions in the embodiments of the present disclosure, brief introduction of the drawings needed to be used in the description of the embodiments will be given below. Obviously, the drawings in the following description are only some embodiments of the present disclosure. Those of ordinary skill in the art can also obtain other drawings based on these drawings without any creative effort.

FIG. 1 is an implementation flow chart of a method for controlling a cross-domain device according to embodiments of the present disclosure.

FIG. 2 is an implementation flow chart of a method for controlling a cross-domain device according to embodiments of the present disclosure.

FIG. 3 is an implementation flow chart of a method for controlling a cross-domain device according to embodiments of the present disclosure.

FIG. 4 is a schematic diagram of a system for controlling a cross-domain device according to embodiments of the present disclosure.

FIG. 5 is an interaction flow chart for controlling a cross-domain device according to embodiments of the present disclosure.

FIG. 6 is an interactive flow chart of first requesting and then discovering smart devices according to embodiments of the present disclosure.

FIG. 7 is an interactive flow chart for first discovering and then requesting smart devices according to embodiments of the present disclosure.

FIG. 8 is an interactive flow chart of first discovering and then requesting smart devices according to embodiments of the present disclosure.

FIG. 9 is a schematic diagram of a control terminal according to embodiments of the present disclosure.

FIG. 10 is a schematic diagram of a control terminal according to embodiments of the present disclosure.

FIG. 11 is a schematic diagram of a server according to embodiments of the present disclosure.

### DETAILED DESCRIPTION

In order to make the purpose, technical solutions and advantages of the present disclosure clearer, the present disclosure will be described in further detail below in conjunction with the accompanying drawings. Obviously, the described embodiments are only some, not all, of the embodiments of the present disclosure. Based on the embodiments in the present disclosure, all other embodiments obtained by those of ordinary skill in the art without making creative efforts fall within the protection scope of the present disclosure.

In the embodiments of the present disclosure, the term “and/or” describes association relationships of associated objects, indicating that there may be three relationships, for example, A and/or B, which may mean: A exists alone, A and B exist simultaneously, and B exists alone. The character “/” generally indicates that the related objects before and after are in an “or” relationship.

The application scenarios described in the embodiments of the present disclosure are to more clearly illustrate the technical solutions of the embodiments of the present disclosure, and do not constitute a limitation on the technical solutions provided by the embodiments of the present disclosure. Those of ordinary skill in the art will know that with the emergence of new application scenarios, the technical solutions provided by the embodiments of the present disclosure are equally applicable to similar technical problems. Here, in the description of the present disclosure, unless otherwise specified, “plurality” means two or more.

Embodiment 1. With the gradual unification of smart home protocols, the application of smart home devices will be applied to a wider range. Devices in a single family can be shared with neighbors or even with users in the entire building, which can satisfy the needs of buyers and meet the needs of some users for temporary use, thereby reducing the purchase of equipment, wiring, energy consumption, etc., and avoiding unnecessary investment. For example, taking a camera as an example, multiple families can share the camera at corridor, and taking a smoke sensor as an example, multiple families can share multiple smoke sensors.

For example, the Matter standard defines that in the field of smart home, a single device can have multiple managers, and the multiple managers can add one or more devices to different domains. Here, the domain is a concept above the network layer. Different domains can use the same network (such as the same Wi-Fi network), but different domains have different Node Operational Certificate (NOC). Multiple managers are responsible for configuration of multiple domains, including adding of a domain device, configuration of NOC, etc. The current process for old managers to add new managers is as follows.

Process 1) an old manager establishes a secure channel with a smart device through a certificate.

Process 2) the old manager triggers the smart device to open a configuration window.

Process 3) the smart device starts a configuration mode and sends a broadcast message through DNS-SD, so that a new manager can discover the smart device through DNS-SD.

Process 4) the new manager establishes a PASE secure session with the smart device.

Process 5) the new manager completes a series of interactions with the smart device, including sending configuration information, authenticating the device, generating an operation certificate, configuring the operation certificate, configuring ACL, configuring network information, etc.

Process 6) the old manager sends a configuration completion message.

Process 7) the smart device completes the configuration, adds the new manager, obtains a new node operation certificate, and can interact with smart devices in the new domain.

Currently, in the process of adding a new manager in a pan-home scenario, the old manager and the new manager need to be present at the same time to ensure the order of execution of the two through offline communication. The new manager also needs to obtain information from the old manager, including text information, voice information, etc., which is cumbersome to operate and is not conducive to the sharing of smart home devices. In addition, after adding a new manager, the new manager has the same authority as the old manager, making it impossible for the old manager to take back the right to use the device in time.

The embodiments of the present disclosure provide a method for controlling a cross-domain device, so that a new manager can easily add a smart device, while ensuring that an old manager have control right over smart devices, promoting the sharing and use of smart devices in pan-home scenarios, and improving the utilization of smart devices while meeting the needs of multiple users. The core concept of the embodiments of the present disclosure is that, the process of a new manager applying to add a smart device through a server and verifying a request from the new manager to an old manager is added, and the management of access control permissions for the new manager by the old manager is added, which can solve the problem that in the current pan-smart home scenario, adding a new manager is cumbersome and the permissions of the new manager are uncontrollable.

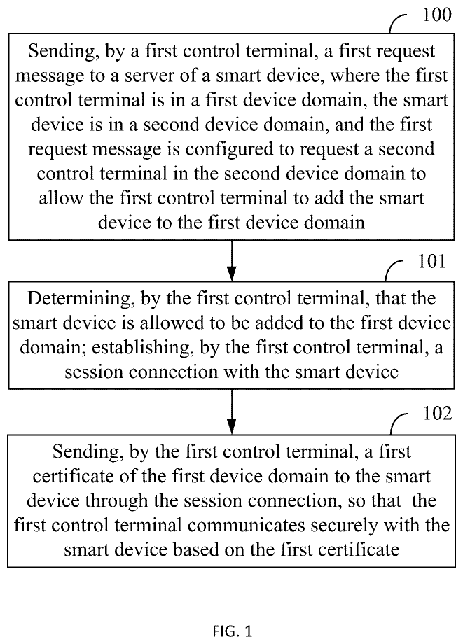

As shown in FIG. 1, embodiments of the present disclosure provide a method for

controlling a cross-domain device, and the method is applied to a first control terminal. It should be noted that the first control terminal in the embodiments of the present disclosure is a control terminal at the new manager side, and is configured to send a request for adding a smart device to a first device domain through a server to a second control terminal (i.e., a control terminal at the old manager side). The specific implementation processes are as follows.

Step 100: the first control terminal sends a first request message to a server of a smart device. The first control terminal is in a first device domain. The smart device is in a second device domain. The first request message is configured to request a second control terminal in the second device domain to allow the first control terminal to add the smart device to the first device domain.

In some embodiments, the smart devices in the embodiments include but are not limited to smart home devices, Internet of Things devices and other devices with wireless communication functions, such as smart air conditioners, smart speakers, camera equipment in floor corridors, smoke sensors and other smart devices in homes or public facilities.

During implementation, the smart device in the embodiments is in the second device

domain configured by the second control terminal. The smart device can communicate securely with the second control terminal, and the second control terminal can control the smart device. Optionally, the second control terminal represents the terminal used by the old manager.

In some embodiments, the first request message includes at least one of an identifier of the first control terminal, a type of the first control terminal, an identifier of the smart device, a request validity period, a request purpose, or a request reason.

Optionally, the first request message includes an identifier of the first control terminal, a request validity period and a request purpose.

Optionally, the first request message includes a type of the first control terminal, a request validity period and a request purpose.

In some embodiments, the first request message includes identity information of the first control terminal. The identity information is used for determining whether the first control terminal satisfies a trigger condition(s) determined by the second control terminal, and when satisfying the trigger condition(s), it is determined that the smart device is allowed to be added to the first device domain.

Optionally, the identity information of the first control terminal includes but is not limited to registered user information of the first control terminal, such as registered user's mobile phone number, SIM card number, ID number and other identity information that characterizes the registered user.

In implementation, the server sends the identity information of the first control terminal to the smart device; the smart device determines whether the first control terminal satisfies the trigger condition(s) determined by the second control terminal according to the identity information, and determines that the smart device is allowed to be added to the first device domain when the trigger condition(s) is/are met. For example, when the smart device detects the first control terminal, the smart device is automatically triggered to enter a configuration mode and is allowed to be added to the first device domain. At this time, the first control terminal can establish a session connection with the smart device.

In some embodiments, the server in the embodiments includes a server registered by the smart device or a smart device with a local server function(s). The server in the embodiments may be independent of the smart device, or may be integrated with the smart device, which will not be limited in the embodiments.

In some embodiments, before sending the first request message to the server, the first control terminal needs to obtain an address of the server of the smart device. The address of the server can be obtained in any of the following manners.

Manner 1) the first control terminal establishes a communication connection with the smart device through NFC or Bluetooth, and obtains the address of the server of the smart device.

In this manner, the first control terminal already knows in advance the smart device and the server of the smart device that are about to establish a communication connection, obtains the address of the server through a Near Field Communication (NFC) function on the first control terminal, and then establishes a secure communication connection with the smart device, or pairs with the smart device through a Bluetooth function of the first control terminal, thereby obtaining the address of the server, and then establishing a secure communication connection with the smart device.

Manner 2) the first control terminal sends a first broadcast message through Domain Name System Service Discovery (DNS-SD), and receives a response message in response to the first broadcast message. The response message includes information associated with the smart device. The first control terminal determines the address of the server of the smart device according to the information associated with the smart device.

In this manner, the first control terminal does not know the smart device and the server of the smart device that are about to establish a communication connection. Therefore, the first control terminal sends the first broadcast message through DNS-SD. The first broadcast message may be sent in unicast or multicast mode, which is configured to request the discovery of a certain type of smart device. After receiving the response message of the first broadcast message, it means that the first control terminal has discovered the smart device and can obtain the address of the server of the smart device according to the information associated with the smart device carried in the response message.

Optionally, the response message includes the address of the server of the smart device.

In some embodiments, after obtaining the address of the server of the smart device, the first control terminal accesses a device page of the smart device according to the address of the server; and sends the first request message to the server through the device page.

In some embodiments, after obtaining the address of the server of the smart device, the first control terminal sends authentication information of the first control terminal to the server according to the address of the server; when the server verifies and passes the authentication information, the first control terminal enters and accesses the device page of the smart device.

Step 101: the first control terminal determines that the smart device is allowed to be added to the first device domain, and the first control terminal establishes a session connection with the smart device.

In some embodiments, the first control terminal receives a second broadcast message sent from the smart device through DNS-SD and determines that the smart device is allowed to be added to the first device domain.

Step 102: the first control terminal sends a first certificate of the first device domain to the smart device through the session connection, so that the first control terminal communicates securely with the smart device based on the first certificate.

In implementation, the first control terminal sends the first certificate of the first device domain to the smart device through the session connection, adds the smart device to the first device domain, and finally implements communication with the smart device. Here, the first control terminal generates the first certificate or obtains the first certificate, such as a node operation certificate, from an authentication server. After receiving the first certificate, the smart device conducts a series of information interactions with the first control terminal to complete the configuration of the new manager. The first control terminal adds the smart device to the first device domain, and the smart device establishes secure communication with the first control terminal.

In some embodiments, the first control terminal controls the smart device according to control authority information determined by the second control terminal. The control authority information includes control authority and control period.

In implementation, after the first control terminal sends the first certificate of the first device domain to the smart device through the session connection, the first control terminal further sends a fourth request message to the smart device through the second control terminal, which indicates that the first control terminal controls control authority information of the smart device, so that the first control terminal controls the smart device according to the control authority information.

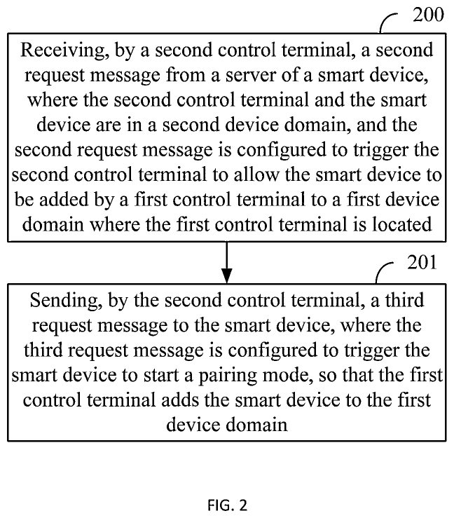

As shown in FIG. 2, the embodiments of the present disclosure further provide a method for controlling a cross-domain device, and the method is applied to a second control terminal. After a server of a smart device receives a first request message sent from a first control terminal, the server sends a second request message to the second control terminal. After receiving the second request message, the second control terminal executes the following processes.

Step 200: the second control terminal receives the second request message sent from the server of the smart device. The second control terminal and the smart device are in a second device domain. The second request message is configured to trigger the second control terminal to allow the smart device to be added by the first control terminal to the first device domain where the first control terminal is located.

In some embodiments, the second request message includes at least one of an identifier of the first control terminal, a type of the first control terminal, an identifier of the smart device, a request validity period, a request purpose, or a request reason.

The request validity period may be a validity period of the smart device receiving a request.

In implementation, at least part of information in the second request message and the first request message are the same, for example, both including the identifier of the first control terminal or the first control terminal type, the request validity period, the request purpose, etc.

In some embodiments, the second request message includes identity information of the first control terminal. The identity information is used for determining whether the first control terminal meets a trigger condition determined by the second control terminal and determining that the smart device is allowed to be added to the first device domain when the trigger condition is met.

Optionally, the identity information includes but is not limited to registered user information of the first control terminal, such as the registered user's mobile phone number, SIM card number, ID number and other identity information that characterizes the registered user.

In implementation, the server sends the identity information of the first control terminal to the smart device; and the smart device determines whether the first control terminal meets the trigger condition determined by the second control terminal based on the identity information, and determines that the smart device is allowed to be added to the first device domain when the trigger condition is met. For example, when the smart device detects the first control terminal, the smart device is automatically triggered to enter a configuration mode and is allowed to be added to the first device domain. At this time, the first control terminal can establish a session connection with the smart device.

In some embodiments, the server includes a server registered by the smart device or a smart device with a local server function.

Step 201: the second control terminal sends a third request message to the smart device. The third request message is configured to trigger the smart device to start a pairing mode, so that the first control terminal adds the smart device to the first device domain.

In some embodiments, the third request message in the embodiments includes at least one of an identifier of the first control terminal, a request validity period, or a start time of the smart device receiving a request.

In some embodiments, the second control terminal may also send a fourth request message to the smart device. The fourth request message is configured to indicate control authority information of the first control terminal on the smart device. Optionally, the fourth request message includes control authority and control period of the first control terminal on the smart device.

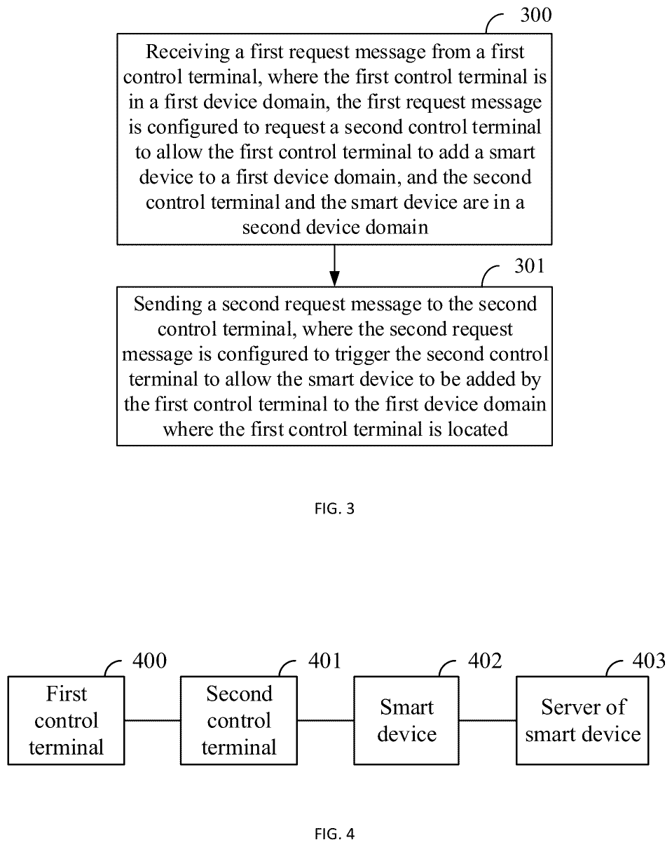

As shown in FIG. 3, the embodiments further provide a method for controlling a cross-domain device, and the method is applied to a server. After the server of the smart device receives the first request message sent from the first control terminal, the server further performs the following processes.

Step 300: the server receives a first request message from a first control terminal. The first control terminal is in a first device domain. The first request message is configured to request a second control terminal to allow the first control terminal to add a smart device to a first device domain. The second control terminal and the smart device are in the second device domain.

In some embodiments, a device page of the smart device is generated, and the first request message from the first control terminal is received through the device page.

In some embodiments, before receiving the first request message from the first control terminal, the first control terminal may also be verified. In implementation, authentication information sent from the first control terminal is received; and when the authentication information is verified and passed, the first request message sent from the first control terminal is received through the device page.

In some embodiments, the first request message includes at least one of an identifier of the first control terminal, a type of the first control terminal, an identifier of the smart device, a request validity period, a request purpose, or a request reason.

Step 301: the server sends a second request message to the second control terminal. The second request message is configured to trigger the second control terminal to allow the smart device to be added by the first control terminal to the first device domain where the first control terminal is located.

In some embodiments, the second request message includes at least one of an identifier of the first control terminal, a type of the first control terminal, an identifier of the smart device, a request validity period, a request purpose, or a request reason.

As shown in FIG. 4, the embodiments further provide a system for controlling a cross-domain device. The system includes a first control terminal 400, a second control terminal 401, a smart device 402, and a server 403 of the smart device.

The first control terminal 400 sends a first request message to the server 403 of the smart device 402.

Here, the first control terminal 400 is in a first device domain, the smart device 402 is in a second device domain, and the first request message is configured to request the second control terminal 401 in the second device domain to allow the first control terminal 400 to add the smart device 402 to the first device domain.

The server 403 sends a second request message to the second control terminal 401.

Here, the second request message is configured to trigger the second control terminal 401 to allow the smart device 402 to be added by the first control terminal 400 to the first device domain where the first control terminal 400 is located.

The second control terminal 401 sends a third request message to the smart device 402.

Here, the third request message is configured to trigger the smart device 402 to start a pairing mode, so that the first control terminal 400 adds the smart device 402 to the first device domain.

The first control terminal 400 determines that the smart device 402 is allowed to be added to the first device domain. The first control terminal 400 establishes a session connection with the smart device 402. The first control terminal 400 sends a first certificate of the first device domain to the smart device 402 through the session connection, so that the first control terminal 400 communicates securely with the smart device 402 based on the first certificate.

In some embodiments, the first request message includes at least one of an identifier of the first control terminal 400, a type of the first control terminal 400, an identifier of the smart device 402, a request validity period, a request purpose, or a request reason.

In some embodiments, the first request message further includes identity information of the first control terminal 400. The identity information is configured by the smart device 402 to determine whether the first control terminal 400 meets a trigger condition determined by the second control terminal 401, and determines that the smart device 402 is allowed to be added to the first device domain when the trigger condition is met.

In some embodiments, the server 403 includes a server 403 registered by the smart device 402 or a smart device 402 with a local server 403 function(s).

In some embodiments, the second request message includes at least one of an identifier of the first control terminal 400, a type of the first control terminal 400, an identifier of the smart device 402, a request validity period, a request purpose, or a request reason.

In some embodiments, the second request message includes identity information of the first control terminal 400. The identity information is configured by the smart device 402 to determine whether the first control terminal 400 meets a trigger condition determined by the second control terminal 401, and determines that the smart device 402 is allowed to be added to the first device domain when the trigger condition is met.

In some embodiments, the third request message includes at least one of an identifier of the first control terminal 401, a request validity period, or a start time of the smart device 402 receiving a request.

In some embodiments, the second control terminal 401 can further send a fourth request message to the smart device 402. The fourth request message is configured to indicate control authority information of the first control terminal 400 on the smart device 402. The first control terminal 400 controls the smart device 402 according to the control authority information determined by the second control terminal 401.

In some embodiments, the fourth request message includes control authority and control period of the first control terminal 400 on the smart device 402.

In some embodiments, the server 403 generates a device page of the smart device 402. The first control terminal 400 obtains an address of the server 403 of the smart device 402, and accesses the device page of the smart device 402 according to the address of the server 403. The first control terminal 400 sends a first request message to the server 403 through the device page.

In some embodiments, the first control terminal 400 obtains the address of the server 403 in any of the following manners.

Manner 1) the first control terminal 400 establishes a communication connection with the smart device 402 through NFC or Bluetooth, and obtains the address of the server 403 of the smart device 402.

Manner 2) the first control terminal 400 sends a first broadcast message through DNS-SD and receives a response message of the first broadcast message, where the response message includes information associated with the smart device 402; and determines the address of the server 403 of the smart device 402 according to the information associated with the smart device 402.

In some embodiments, the first control terminal 400 is further configured to send authentication information of the first control terminal 400 to the server 403 according to the address of the server 403. When the server 403 verifies and passes the authentication information, the first control terminal 400 enters and accesses the device page of the smart device 402.

In some embodiments, the first control terminal 400 determines that the smart device 402 is allowed to be added to the first device domain in the following way.

The first control terminal 400 receives the second broadcast message sent from the smart device 402 through DNS-SD, and determines that the smart device 402 is allowed to be added to the first device domain.

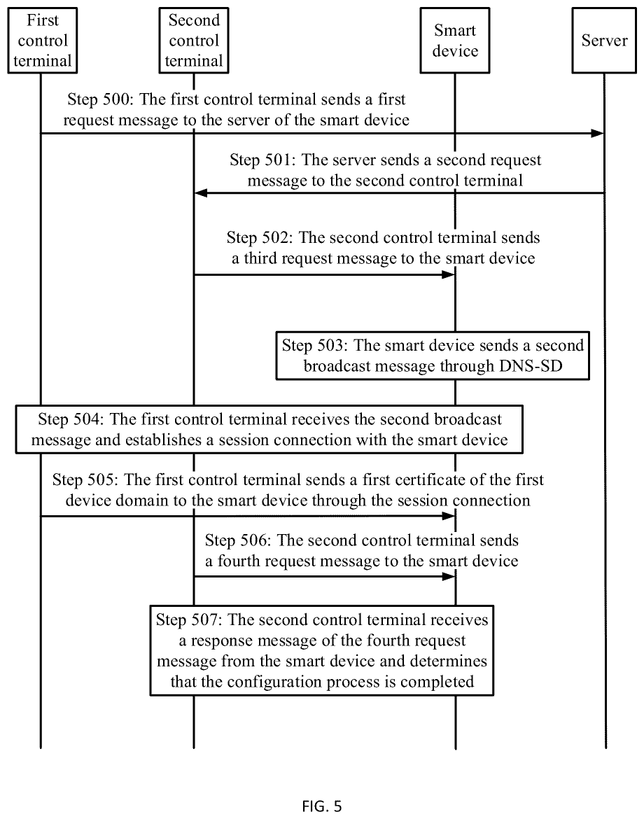

As shown in FIG. 5, the embodiments further provides an interaction flow chart for controlling cross-domain devices, and the interaction processes among respective devices in the system are specifically as follows.

Step 500: the first control terminal sends a first request message to the server of the smart device.

Here, the first control terminal is in the first device domain, the smart device is in the second device domain, and the first request message is configured to request the second control terminal in the second device domain to allow the first control terminal to add the smart device to the first device domain.

Step 501: the server sends a second request message to the second control terminal.

Here, the second request message is configured to trigger the second control terminal to allow the smart device to be added by the first control terminal to the first device domain where the first control terminal is located.

Step 502: the second control terminal sends a third request message to the smart device.

Here, the third request message is configured to trigger the smart device to start a pairing mode, so that the first control terminal adds the smart device to the first device domain.

Step 503: the smart device sends a second broadcast message through DNS-SD.

Step 504: the first control terminal receives the second broadcast message and establishes a session connection with the smart device.

Step 505: the first control terminal sends a first certificate of the first device domain to the smart device through the session connection.

Step 506: the second control terminal sends a fourth request message to the smart device.

Here, the fourth request message is configured to indicate control authority information of the first control terminal on the smart device, and the fourth request message includes control authority and control period of the first control terminal on the smart device.

Step 507: the second control terminal receives a response message of the fourth request message from the smart device and determines that the configuration process is completed.

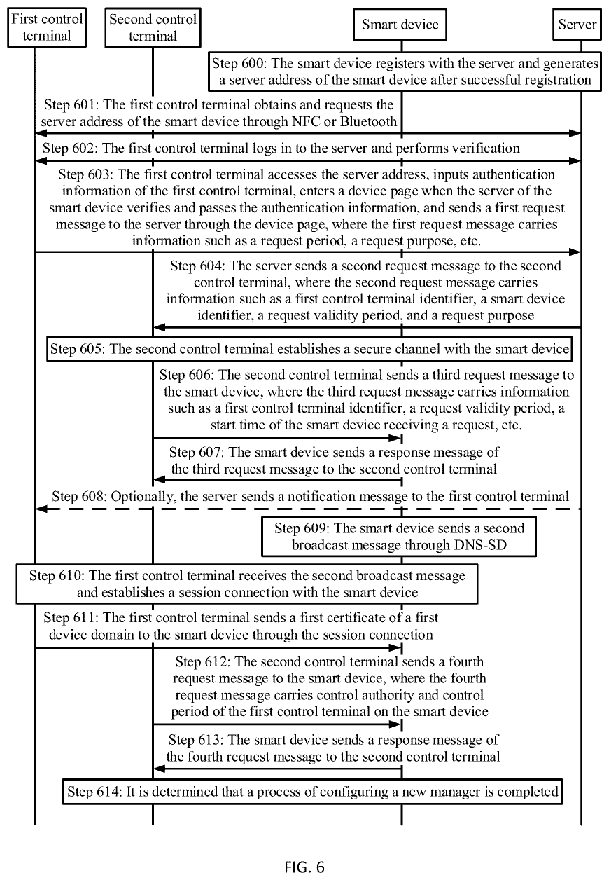

As shown in FIG. 6, the embodiments provide an interactive process of first requesting and then discovering a smart device. The specific implementation of the process is as follows.

Step 600: the smart device registers with the server and generates an address of the server of the smart device after successful registration.

Here, the smart device has been added to the second device domain by the second control terminal.

Step 601: the first control terminal obtains and requests the address of the server of the smart device through NFC or Bluetooth.

Step 602: the first control terminal logs in to the server and performs verification.

Optionally, the server includes a device server and a verification server. The first control terminal can access the address of the server of the smart device only after passing verification by the verification server.

Step 603: the first control terminal accesses the address of the server, inputs authentication information of the first control terminal, enters a device page when the server of the smart device verifies and passes the authentication information, and sends a first request message to the server through the device page, where the first request message carries information such as a request period, a request purpose, etc.

Step 604: the server sends a second request message to the second control terminal, where the second request message carries information such as an identifier of the first control terminal, an identifier of the smart device, a request validity period, and a request purpose.

Step 605: the second control terminal establishes a secure channel with the smart device.

Here, all messages of the second control terminal and the smart device are encrypted using a key generated by CASE.

Step 606: the second control terminal sends a third request message to the smart device, where the third request message carries information such as an identifier of the first control terminal, a request validity period, a start time of the smart device receiving a request, etc.

Step 607: the smart device sends a response message of the third request message to the second control terminal.

Step 608: optionally, the server sends a notification message to the first control terminal.

Here, the notification message is configured to notify the smart device requested by the first control terminal to enter an allowed pairing mode.

Step 609: the smart device sends a second broadcast message through DNS-SD.

Step 610: the first control terminal receives the second broadcast message and establishes a session connection with the smart device.

Optionally, the first control terminal and the smart device establish a PASE secure channel. All messages of the first control terminal and the smart device are received and sent through the PASE secure channel. The first control terminal sends configuration information to the smart device, including UTC time, etc. The first control terminal authenticates the smart device and sends an authentication device signal request to the smart device, so that the smart device generates a new public key and private key pair, and the public key and private key pair are configured for communication with the smart device in the first device domain.

Step 611: the first control terminal sends a first certificate of a first device domain to the smart device through the session connection.

Optionally, the first control terminal generates a node operation certificate or obtains a node operation certificate from the authentication server, and sends the node operation certificate to the smart device.

Optionally, the first control terminal configures an access control policy, network information, etc., for the smart device.

Step 612: the second control terminal sends a fourth request message to the smart device, where the fourth request message carries control authority and control period of the first control terminal on the smart device.

Step 613: the smart device sends a response message of the fourth request message to the second control terminal.

Step 614: it is determined that a process of configuring a new manager is completed.

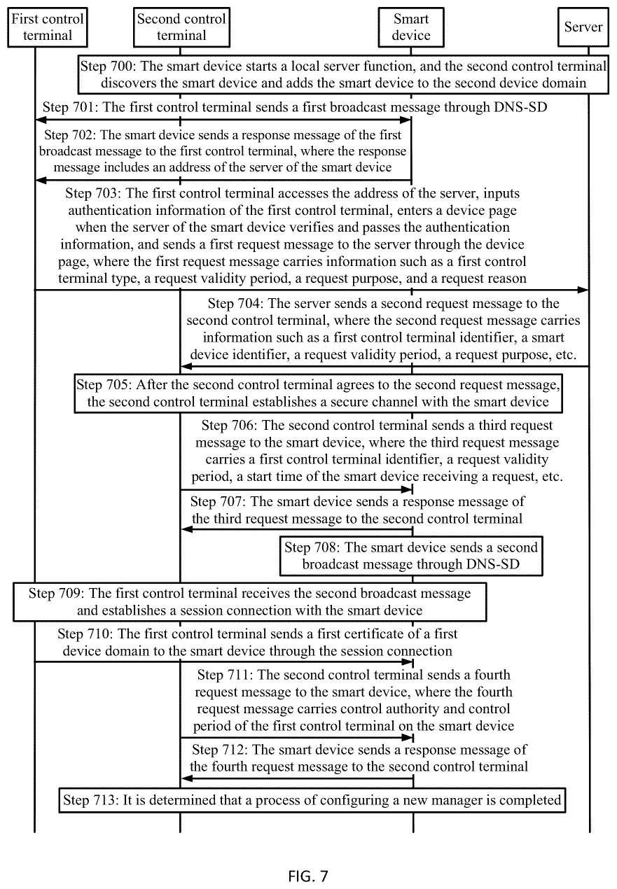

As shown in FIG. 7, the embodiments provide an interactive process of first discovering and then requesting a smart device. The specific implementation of the process is as follows.

Step 700: the smart device starts a local server function, and the second control terminal discovers the smart device and adds the smart device to the second device domain.

Step 701: the first control terminal sends a first broadcast message through DNS-SD

Step 702: the smart device sends a response message of the first broadcast message to the first control terminal, where the response message includes an address of the server of the smart device.

Step 703: the first control terminal accesses the address of the server, inputs authentication information of the first control terminal, enters a device page when the server of the smart device verifies and passes the authentication information, and sends a first request message to the server through the device page, where the first request message carries information such as a type of the first control terminal, a request validity period, a request purpose, and a request reason.

Optionally, the server includes a device server and a verification server. The first control terminal can access the address of the server of the smart device only after passing verification by the verification server.

Step 704: the server sends a second request message to the second control terminal, where the second request message carries information such as an identifier of the first control terminal, an identifier of the smart device, a request validity period, a request purpose, etc.

Step 705: after the second control terminal agrees to the second request message, the second control terminal establishes a secure channel with the smart device.

Here, all messages of the second control terminal and the smart device are encrypted using a key generated by CASE.

Step 706: the second control terminal sends a third request message to the smart device, where the third request message carries an identifier of the first control terminal, a request validity period, a start time of the smart device receiving a request, etc.

Step 707: the smart device sends a response message of the third request message to the second control terminal.

Step 708: the smart device sends a second broadcast message through DNS-SD.

Step 709: the first control terminal receives the second broadcast message and establishes a session connection with the smart device.

Optionally, the first control terminal and the smart device establish a PASE secure channel. All messages between the first control terminal and the smart device are received and sent through the PASE secure channel. The first control terminal sends configuration information to the smart device, including UTC time, etc. The first control terminal authenticates the smart device and sends an authentication device signal request to the smart device, so that the smart device generates a new public key and private key pair, and the public key and private key pair are configured for communication with the smart device in the first device domain.

Step 710: the first control terminal sends a first certificate of a first device domain to the smart device through the session connection.

Optionally, the first control terminal generates a node operation certificate or obtains a node operation certificate from the authentication server and sends the node operation certificate to the smart device.

Optionally, the first control terminal configures an access control policy, network information, etc., to the smart device.

Step 711: the second control terminal sends a fourth request message to the smart device, where the fourth request message carries control authority and control period of the first control terminal on the smart device.

Step 712: the smart device sends a response message of the fourth request message to the second control terminal.

Step 713: it is determined that a process of configuring a new manager is completed.

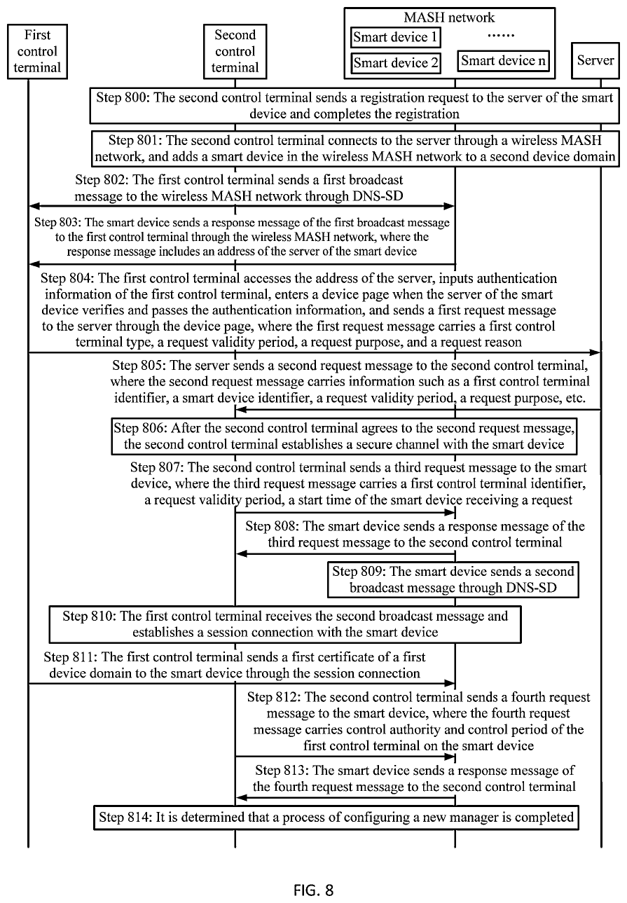

As shown in FIG. 8, the embodiments provide an interactive process of first discovering and then requesting a smart device. The smart device is in a wireless autonomous network (wireless MASH network). The wireless MASH network is composed of multiple smart devices. The specific implementation of the process is as follows.

Step 800: the second control terminal sends a registration request to the server of the smart device and completes the registration.

Step 801: the second control terminal connects to the server through the wireless MASH network, and adds a smart device in the wireless MASH network to a second device domain.

Step 802: the first control terminal sends a first broadcast message to the wireless MASH network through DNS-SD.

Step 803: the smart device sends a response message of the first broadcast message to the first control terminal through the wireless MASH network, where the response message includes an address of the server of the smart device.

Here, if there is no smart device requested by the first broadcast message in the wireless MASH network, no response message of the first broadcast message is returned.

Step 804: the first control terminal accesses the address of the server, inputs authentication information of the first control terminal, enters a device page when the server of the smart device verifies and passes the authentication information, and sends a first request message to the server through the device page, where the first request message carries a type of the first control terminal, a request validity period, a request purpose, and a request reason.

Optionally, the server includes a device server and a verification server. The first control terminal can access the address of the server of the smart device only after passing verification by the verification server.

Step 805: the server sends a second request message to the second control terminal, where the second request message carries information such as an identifier of the first control terminal, an identifier of the smart device, a request validity period, a request purpose, etc.

Step 806: after the second control terminal agrees to the second request message, the second control terminal establishes a secure channel with the smart device.

Here, all messages between the second control terminal and the smart device are encrypted using a key generated by CASE.

Step 807: the second control terminal sends a third request message to the smart device, where the third request message carries an identifier of the first control terminal, a request validity period, a start time of the smart device receiving a request.

Step 808: the smart device sends a response message of the third request message to the second control terminal.

Step 809: the smart device sends a second broadcast message through DNS-SD.

Step 810: the first control terminal receives the second broadcast message and establishes a session connection with the smart device.

Optionally, the first control terminal and the smart device establish a PASE secure channel. All messages between the first control terminal and the smart device are received and sent through the PASE secure channel; the first control terminal sends configuration information to the smart device, including UTC time, etc. The first control terminal authenticates the smart device and sends an authentication device signal request to the smart device, so that the smart device generates a new public key and private key pair, and the public key and private key pair are configured for communication with the smart device in the first device domain.

Step 811: the first control terminal sends a first certificate of a first device domain to the smart device through the session connection.

Optionally, the first control terminal generates a node operation certificate or obtains a node operation certificate from the authentication server and sends the node operation certificate to the smart device.

Optionally, the first control terminal configures an access control policy, network information, etc., to the smart device.

Step 812: the second control terminal sends a fourth request message to the smart device, where the fourth request message carries control authority and control period of the first control terminal on the smart device.

Step 813: the smart device sends a response message of the fourth request message to the second control terminal.

Step 814: it is determined that a process of configuring a new manager is completed.

Embodiment 2. Based on the same inventive concept, the embodiments of the present disclosure further provide a control terminal. Since the control terminal is the control terminal in the methods in the embodiments of the present disclosure, and the principle of solving the problem by the control terminal is the similar as that of the method, so the implementation of the control terminal can be referred to the implementation of the method, which will not be repeated herein.

It should be noted that the control terminal is a device with wireless communication functions and can be deployed on land, including indoors or outdoors, handheld or vehicle-mounted. The control terminal can also be deployed on water (such as ships, etc.). The control terminal can also be deployed in the air (such as airplanes, balloons, satellites, etc.). The terminal may be a mobile phone, a pad, a computer with wireless transceiver functions, or various forms of UE or terminal device.

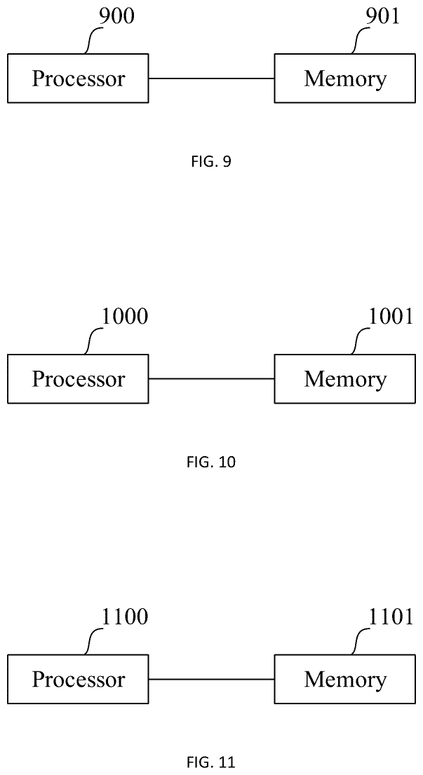

As shown in FIG. 9, the control terminal includes a processor 900 and a memory 901. The memory 901 is configured to store programs executable by the processor 900. The processor 900 is configured to read the programs in the memory 901 and perform the following steps.

The control terminal sends a first request message to a server of a smart device. The control terminal is in a first device domain, and the smart device is in a second device domain. The first request message is configured to request the second control terminal in the second device domain to allow the control terminal to add the smart device to the first device domain.

The control terminal determines that the smart device is allowed to be added to the first device domain, and the control terminal establishes a session connection with the smart device.

The control terminal sends a first certificate of the first device domain to the smart device through the session connection, so that the control terminal communicates securely with the smart device based on the first certificate.

As an optional embodiment, the processor 900 is specifically configured to execute:
the control terminal controlling the smart device according to control authority information determined by the second control terminal, where the control authority information includes control authority and control period.

As an optional embodiment, the processor 900 is specifically configured to execute:
the control terminal obtaining an address of the server of the smart device and accesses a device page of the smart device according to the address of the server;
the control terminal sending a first request message to the server through the device page.

As an optional embodiment, the processor 900 is specifically configured to execute:
the control terminal establishing a communication connection with the smart device through NFC or Bluetooth, and obtaining the address of the server of the smart device.

As an optional embodiment, the processor 900 is specifically configured to execute:
the control terminal sending a first broadcast message through DNS-SD and receiving a response message of the first broadcast message, where the response message includes information associated with the smart device;
determining the address of the server of the smart device based on the information associated with the smart device.

As an optional embodiment, the processor 900 is specifically configured to execute:
the control terminal sending authentication information of the control terminal to the server according to the address of the server;
when the server verifies and passes the authentication information, the control terminal entering and accessing the device page of the smart device.

As an optional embodiment,
the first request message includes at least one of a control terminal identifier, a control terminal type, an identifier of the smart device, a request validity period, a request purpose, or a request reason.

As an optional embodiment,
the first request message includes identity information of the control terminal, where the identity information is used for determining whether the control terminal meet a trigger condition determined by the second control terminal, and determining that the smart device is allowed to be added to the first device domain when the trigger condition is met.

As an optional embodiment,
the server includes a server registered by the smart device or a smart device with a local server function(s).

As an optional embodiment, the processor 900 is specifically configured to execute:
the control terminal receiving the second broadcast message sent from the smart device through DNS-SD and determining that the smart device is allowed to be added to the first device domain.

Embodiment 3. Based on the same inventive concept, the embodiments of the present disclosure further provide a control terminal. Since the control terminal is the control terminal in the methods in the embodiments of the present disclosure, and the principle of solving the problem by the control terminal is the similar as that of the method, so the implementation of the control terminal can be referred to the implementation of the method, which will not be repeated herein.

It should be noted that the control terminal is a device with wireless communication functions and can be deployed on land, including indoors or outdoors, handheld or vehicle-mounted. The control terminal can also be deployed on water (such as ships, etc.). The control terminal can also be deployed in the air (such as airplanes, balloons, satellites, etc.). The terminal may be a mobile phone, a pad, a computer with wireless transceiver functions, or various forms of UE or terminal device.

As shown in FIG. 10, the control terminal includes a processor 1000 and a memory 1001. The memory 1001 is configured to store programs executable by the processor 1000. The processor 1000 is configured to read the programs in the memory 1001 and perform the following steps.

The control terminal receives a second request message sent from a server of the smart device. The control terminal and the smart device are in the second device domain. The second request message is configured to trigger the control terminal to allow the smart device to be added by the first control terminal to the first device domain where the first control terminal is located.

The control terminal sends a third request message to the smart device. The third request message is configured to trigger the smart device to start a pairing mode, so that the first control terminal adds the smart device to the first device domain.

As an optional embodiment, the processor 1000 is specifically configured to execute:
the control terminal sending a fourth request message to the smart device, where the fourth request message is configured to indicate control authority information of the first control terminal on the smart device.

As an optional embodiment,
the fourth request message includes control authority and control period of the first control terminal on the smart device.

As an optional embodiment,
the second request message includes at least one of an identifier of the first control terminal, a type of the first control terminal, an identifier of the smart device, a request validity period, a request purpose, or a request reason.

As an optional embodiment,
the third request message includes at least one of an identifier of the first control terminal, a request validity period, or a start time of the smart device receiving a request.

As an optional embodiment,
the second request message includes identity information of the first control terminal. The identity information is used for determining whether the first control terminal meet a trigger condition determined by the control terminal, and determining that the smart device is allowed to be added to the first device domain when the trigger condition is met.

As an optional embodiment,
the server includes a server registered by the smart device or a smart device with a local server function(s).

Embodiment 4. Based on the same inventive concept, the embodiments of the present disclosure further provide a server. Since the server is the server in the methods in the embodiments of the present disclosure, and the principle of solving the problem by the server is similar to the method, therefore the implementation of the server can be referred to the implementation of the method, which will not be repeated herein.

It should be noted that the server in the embodiments can be a separate server device or a smart device with server functions. Optionally, the server in the embodiments can be a server registered by a smart device or a smart device with a local server function(s).

As shown in FIG. 11, a server provided by the embodiments of the present disclosure includes a processor 1100 and a memory 1101. The memory 1101 is configured to store programs executable by the processor 1100. The processor 1100 is configured to read the programs in memory 1101 and perform the following steps:
receiving a first request message sent from a first control terminal, where the first control terminal is in a first device domain, the first request message is configured to request a second control terminal to allow the first control terminal to add the smart device to the first device domain; the second control terminal and the smart device are in the second device domain;
sending a second request message to the second control terminal, where the second request message is configured to trigger the second control terminal to allow the smart device to be added by the first control terminal to the first device domain where the first control terminal is located.

As an optional embodiment, the processor 1100 is specifically configured to execute:
generating a device page of the smart device, and receiving a first request message sent from the first control terminal through the device page.

As an optional embodiment, the processor 1100 is specifically configured to execute:
receiving authentication information from the first control terminal;
when the authentication information is verified and passed, receiving the first request message from the first control terminal through the device page.

As an optional embodiment,
the first request message includes at least one of an identifier of the first control terminal, a type of the first control terminal, an identifier of the smart device, a request validity period, a request purpose, or a request reason.

As an optional embodiment,
the second request message includes at least one of an identifier of the first control terminal, a type of the first control terminal, an identifier of the smart device, a request validity period, a request purpose, or a request reason.

Based on the same inventive concept, the embodiments of the present disclosure further provide a computer storage medium on which computer programs are stored. The programs are configured to implement the following steps when executed by a processor.

The first control terminal sends a first request message to the server of the smart device. The first control terminal is in the first device domain. The smart device is in the second device domain. The first request message is configured to request the second control terminal in the second device domain to allow the first control terminal to add the smart device to the first device domain.

The first control terminal determines that the smart device is allowed to be added to the first device domain, and the first control terminal establishes a session connection with the smart device.

The first control terminal sends the first certificate of the first device domain to the smart device through the session connection, so that the first control terminal communicates securely with the smart device based on the first certificate.

Based on the same inventive concept, the embodiments of the present disclosure further provide a computer storage medium on which computer programs are stored. The programs are configured to implement the following steps when executed by a processor.

The second control terminal receives a second request message from the server of the smart device, the second control terminal and the smart device are in the second device domain, and the second request message is configured to trigger the second control terminal to allow the smart device to be added by the first control terminal to the first device domain where the first control terminal is located.

The second control terminal sends a third request message to the smart device. The third request message is configured to trigger the smart device to start a pairing mode, so that the first control terminal adds the smart device to the first device domain.

Based on the same inventive concept, the embodiments of the present disclosure further provide a computer storage medium on which computer programs are stored. The programs are configured to implement the following steps when executed by a processor:
receiving a first request message from a first control terminal, where the first control terminal is in the first device domain, the first request message is configured to request the second control terminal to allow the first control terminal to add the smart device to the first device domain; the second control terminal and the smart device are in the second device domain;
sending a second request message to the second control terminal, where the second request message is configured to trigger the second control terminal to allow the smart device to be added by the first control terminal to the first device domain where the first control terminal is located.

Those skilled in the art will appreciate that the embodiments of the present disclosure may be provided as methods, systems, or computer program products. Therefore, the present disclosure may take the form of an entirely hardware embodiment, an entirely software embodiment, or an embodiment that combines software and hardware aspects. Furthermore, the present disclosure may take the form of a computer program product embodied on one or more computer-usable storage media (including, but not limited to, magnetic disk storage, optical storage, and the like) embodying computer-usable program codes therein.

The present disclosure is described with reference to flowchart illustrations and/or block diagrams of methods, apparatus (systems), and computer program products according to the embodiments of the present disclosure. It will be understood that each process and/or block in the flowchart illustrations and/or block diagrams, and combinations of processes and/or blocks in the flowchart illustrations and/or block diagrams, can be implemented by computer program instructions. These computer program instructions may be provided to a processor of a general purpose computer, special purpose computer, embedded processor, or other programmable data processing device to produce a machine, such that the instructions executed by the processor of the computer or other programmable data processing device produce equipment configured to implement the functions specified in a process or processes in a flow diagram and/or a block or blocks in a block diagram.

These computer program instructions may also be stored in a computer-readable memory that causes a computer or other programmable data processing device to operate in a particular manner, such that the instructions stored in the computer-readable memory produce an article of manufacture including the instructed device. The instructed device implements the functions specified in a process or processes in a flowchart diagram and/or in a block or blocks in a block diagram.

These computer program instructions may also be loaded onto a computer or other programmable data processing device, causing a series of operating steps to be performed on the computer or other programmable device to produce computer-implemented processing, thereby the instructions executed on the computer or other programmable device are provided with steps of functions specified in a process or processes of a flowchart diagram and/or a block or blocks in a block diagram.

Obviously, those skilled in the art can make various changes and modifications to the present disclosure without departing from the spirit and scope of the present disclosure. In this way, if these modifications and variations of the present disclosure fall within the scope of the claims of the present disclosure and equivalent technologies, the present disclosure is also intended to include these modifications and variations.

1-40. (canceled)

41. A method for controlling a cross-domain device, comprising:
sending, by a first control terminal, a first request message to a server of a smart device, wherein the first control terminal is in a first device domain, the smart device is in a second device domain, and the first request message is configured to request a second control terminal in the second device domain to allow the first control terminal to add the smart device to the first device domain;
determining, by the first control terminal, that the smart device is allowed to be added to the first device domain; establishing, by the first control terminal, a session connection with the smart device; and
sending, by the first control terminal, a first certificate of the first device domain to the smart device through the session connection, so that the first control terminal communicates securely with the smart device based on the first certificate.

42. The method according to claim 41, further comprising:
controlling, by the first control terminal, the smart device according to control authority information determined by the second control terminal, wherein the control authority information comprises control authority and control period.

43. The method according to claim 41, wherein the sending, by the first control terminal, the first request message to the server of the smart device, comprises:
obtaining, by the first control terminal, an address of the server of the smart device, and accessing a device page of the smart device according to the address of the server; and
sending, by the first control terminal, the first request message to the server via the device page.

44. The method according to claim 43, wherein the obtaining, by the first control terminal, the address of the server of the smart device, comprises:
establishing, by the first control terminal, a communication connection with the smart device through Near Field Communication (NFC) or Bluetooth, and obtaining the address of the server of the smart device through the communication connection.

45. The method according to claim 43, wherein the obtaining, by the first control terminal, the address of the server of the smart device, comprises:
sending, by the first control terminal, a first broadcast message through Domain Name System Service Discovery (DNS-SD), and receiving a response message of the first broadcast message, wherein the response message comprises information associated with the smart device; and
determining the address of the server of the smart device according to the information associated with the smart device.

46. The method according to claim 43, wherein the accessing, by the first control terminal, the device page of the smart device according to the address of the server, comprises:
sending, by the first control terminal, authentication information of the first control terminal to the server according to the address of the server; and
based on the server verifies and passes the authentication information, entering and accessing, by the first control terminal, the device page of the smart device.

47. The method according to claim 41, wherein,
the first request message comprises at least one of an identifier of the identifier of the first control terminal, a type of the first control terminal, an identifier of the smart device, a request validity period, a request purpose, or a request reason.

48. The method according to claim 41, wherein the first request message comprises identity information of the first control terminal;
wherein the identity information is used for determining whether the first control terminal meets a trigger condition determined by the second control terminal and determining that the smart device is allowed to be added to the first device domain when the trigger condition is met.

49. The method according to claim 41, wherein,
the server comprises a server registered by the smart device or a smart device with a local server function;
wherein the determining, by the first control terminal, that the smart device is allowed to be added to the first device domain, comprises:
receiving, by the first control terminal, a second broadcast message from the smart device through Domain Name System Service Discovery (DNS-SD), and determining that the smart device is allowed to be added to the first device domain based on the second broadcast message.

50. A method for controlling a cross-domain device, comprising:
receiving, by a second control terminal, a second request message from a server of a smart device, wherein the second control terminal and the smart device are in a second device domain, and the second request message is configured to trigger the second control terminal to allow the smart device to be added by a first control terminal to a first device domain where the first control terminal is located; and
sending, by the second control terminal, a third request message to the smart device, wherein the third request message is configured to trigger the smart device to start a pairing mode, so that the first control terminal adds the smart device to the first device domain.

51. The method according to claim 50, further comprising:
sending, by the second control terminal, a fourth request message to the smart device, wherein the fourth request message is configured to indicate control authority information of the first control terminal on the smart device.

52. The method according to claim 50, wherein
a fourth request message comprises control authority and control period of the first control terminal on the smart device;
wherein the second request message comprises at least one of an identifier of the first control terminal, a type of the first control terminal, an identifier of the smart device, a request validity period, a request purpose, or a request reason;
wherein the third request message comprises at least one of an identifier of the first control terminal, a request validity period, or a start time of the smart device receiving a request;
wherein the second request message comprises identity information of the first control terminal;
wherein the identity information is used for determining whether the first control terminal meets a trigger condition determined by the second control terminal and determining that the smart device is allowed to be added to the first device domain when the trigger condition is met.

53. The method according to claim 50, wherein,
the server comprises a server registered by the smart device or a smart device with a local server function.

54. A method for controlling a cross-domain device, comprising:
receiving a first request message from a first control terminal, wherein the first control terminal is in a first device domain, the first request message is configured to request a second control terminal to allow the first control terminal to add a smart device to a first device domain, and the second control terminal and the smart device are in a second device domain; and
sending a second request message to the second control terminal, wherein the second request message is configured to trigger the second control terminal to allow the smart device to be added by the first control terminal to the first device domain where the first control terminal is located.

55. The method according to claim 54, wherein the receiving the first request message from the first control terminal, comprises:
generating a device page of the smart device, and receiving the first request message from the first control terminal through the device page.

56. The method according to claim 55, wherein the receiving the first request message from the first control terminal through the device page, comprises:
receiving authentication information from the first control terminal; and
based on the authentication information is verified and passed, receiving the first request message from the first control terminal through the device page.

57. The method according to claim 54, wherein:
the first request message comprises at least one of an identifier of the first control terminal, a type of the first control terminal, an identifier of the smart device, a request validity period, a request purpose, or a request reason; and/or
the second request message comprises at least one of an identifier of the first control terminal, a type of the first control terminal, an identifier of the smart device, a request validity period, a request purpose, or a request reason.

58. A control terminal, comprising a processor and a memory, wherein the memory is configured to store programs executable by the processor, and the processor is configured to read the programs in the memory and execute steps of the method according to claim 41.

59. A control terminal, comprising a processor and a memory, wherein the memory is configured to store programs executable by the processor, and the processor is configured to read the programs in the memory and execute steps of the method according to claim 50.

60. A server, comprising a processor and a memory, wherein the memory is configured to store programs executable by the processor, and the processor is configured to read the programs in the memory and execute steps of the method according to claim 54.
